(19) United States
(12) Patent Application Publication
(10) Pub. No.: US 2012/0165048 A1
(43) Pub. Date: Jun. 28, 2012

(54) Messaging Center, User Equipment, and Methods for Message Translation

(75) Inventor: Zhongwen Zhu, Saint-Laurent (CA)

(73) Assignee: TELEFONAKTIEBOLAGET L M ERICSSON (PUBL), Stockholm (SE)

(21) Appl. No.: 12/977,683

(22) Filed: Dec. 23, 2010

(51) Int. Cl. G06F 17/28; H04W 4/14

(52) U.S. Cl. 455/466; 704/2; 704/3

(57) ABSTRACT

A messaging center (e.g. SMS, MMS, IM, email center), User Equipment (UE) and methods are provided to facilitate delivery of messages to recipients in the language used by those recipients. A message written in a first language is first delivered to a recipient, optionally including a delivery report request. The recipient's UE determines if proper message delivery took place based, for example, on a match between the first language (and/or it character set) and a second language (and/or its character set) used by the recipient's UE. In case of a mismatch, the recipient's UE sends back to the messaging center an improper delivery report optionally including an indication of the second language (and/or character set). The messaging center determines the second language based on the indication or via other means, translates the message into the second language, and re-sends it to the recipient's UE.

### TECHNICAL FIELD

The present invention relates to the field of translation of messages for messaging applications.

### BACKGROUND

The evolution in the area of computers allowed the provision of various messaging technologies that users can employ to exchange text based messages. In some instances, such as for example with email messaging, users can not only exchange text but also embed file attachments to a message in order to share multimedia files. Other messaging technologies include the Short Messaging Service (SMS) over cellular networks, Multimedia Messaging System (MMS) also used over cellular networks, Instant Messaging (IM) over the Internet, Local Area Networks (LAN), or over cellular networks, and others.

For example, SMS is one of the most popular messaging services provided by telecom operators so far. However, with the ongoing democratization of messaging technologies, a major drawback has appeared, in that users from across the planet, find themselves in instances to communicate with each other without necessarily knowing each others' language. When the sending user knows the recipient user, normally this problem is solved, since the sending user employs a language that the recipient understands. However, in many other instances, for example including (large) user groups communications, commercial applications, and other one-to-many advertisement campaigns using messaging technologies, it is difficult or even impossible for a sender to know the languages understood by each recipient of the message. The result is that many messages are received in languages that the recipients do not understand and therefore such messages are useless, utilize the networks bandwidth unnecessarily, and even irritate the recipient end-users.

In the area of messaging, a number of technologies exist that attempt to solve the above-mentioned limitations. For example, services like those provided by Kwintessential™ and Interlecta™ follow a traditional translation model, in that they require the sending user to input the message text and to specify the desired translation from a specified original language into a specified target language. Based on the sending user input, translation takes place so that the message (e.g. SMS) is transmitted from the start in the recipient user's language. While this approach may solve the problem in the individual instance when the sender knows the recipient's language, its stops short of applying to the one to many messaging models. Furthermore, this approach is also cumbersome for the user since it requires multiple steps related to the selection of a first, and a second language, and the provision of the original message, plus an active command to perform the translation.

Other SMS translation technologies exit. For example, the 2010 Shanghai World Expo provided a free automated SMS translation service for mandarin speaking visitors. The service enabled their users to use their mobile phone as a mobile translation machine. With this service, the user first sends a short message in Mandarin Chinese to the service provider and he/she receives back the English translation after a few seconds. The Expo organizers hoped that the free SMS translation service would enable Chinese visitors to interact more frequently with the foreign pavilion staffs. The service provided helpful assistance to people who do not use English often and tend to forget basic English words and phrases. However, this translation service is only available for translation between two pre-selected languages and is not destined for regular user-to-user messaging translation.

In the vast majority of user-to-user messaging communications, the language used in an SMS message, for example, is unchanged in the transmission of the message from the sending side up to the receiving side. For instance, the sender constructs the message in e.g. Mandarin Chinese and sends it to the intended recipient. The message originally written in Mandarin Chinese arrives at the recipient side in Mandarin Chinese. However, if the user at the receiving end does not understand Mandarin Chinese or if the user's equipment (UE) default language does not support Mandarin Chinese characters the message can not be displayed properly or can not be recognized by the recipient user. Such a problem can not be solved with the existing translation technologies mentioned hereinabove. If the sender does not know the language understood by the recipient user, or the language character set that the recipient user device can display, the entire sequence of actions of creating, sending, and receiving a message may be useless.

Although there is no prior art solution as the one proposed hereinafter for solving the above-mentioned deficiencies, the U.S. Pat. No. 7,409,333 bears some relation with the filed of the present invention. This patent teaches a system where a sending user can determine the target language for translating an outgoing message so that the message is translated in the recipient's language before being sent out. A comparison takes place on the sending side between the language used by the sender and the language used by the recipient, in order to determine if translation is needed. When a mismatch between the sender's and the recipient's languages is detected, the message is sent to a central site for translation before being sent out to the recipient.

The U.S. Pat. No. 7,315,613 also bears some relation with the filed of the present invention. In this patent, the user can also select a message to be translated into a different language and such a translation can be automatically performed, for example, based on the addressee's language, which can be indicated by a flag shown next to the persons' name in the sender's address book. In both the U.S. Pat. No. 7,315,613 and 7,409,333 patents, the disclosed methods require the sender side to be aware of the language used by the recipient user. This can be a drawback in many instances when the sender does not know the recipient user's preferred language, or when the user does not have the time to input the recipient user's preferred language.

The US Publication US2009/0043562 A1 also bears some relation with the filed of the present invention. Disclosed therein is a method and apparatus for displaying messages in the user's selected language. A recipient's device receives a message in a sender's selected language and translates the message into a user's selected language to form a translated message before displaying it on the display of the recipient's device. According to this method, the receiver device first identifies the sender's selected language and further needs to select a translator for the sender's selected language. This requires the download of translation dictionaries on the recipient user's device for each combination of source language and target language.

The above mentioned translation techniques require the intervention of either the sending user who has to actively select a target language for translation, or of the recipient user who has to download translator dictionaries on his or her user equipment and to select which one to use based on the sender's language. Accordingly, it should be readily appreciated that in order to overcome the deficiencies and shortcomings of the existing solutions, it would be advantageous to have an improved and simpler method of messaging translation. The present invention provides such techniques.

### SUMMARY

According to a preferred embodiment of the invention, there is provided a method for message translation. According to the method, first a message written in a first language is sent from a messaging center to a recipient's User Equipment (UE) and in response to the sending of the message, an indication of improper delivery of the message to the recipient's UE is further received. The method determines a second language associated with the recipient's UE, and allows for requesting by the messaging center a translation of the message from the first language into the second language associated with the recipient's UE, and for the sending of the message translated into the second language to the recipient's UE.

According to another preferred embodiment of the invention, there is provided a method for message translation comprising the steps of receiving at the UE a message written in a first language, and responsive to the received message, sending an indication of improper delivery of the message to the recipient's UE, the indication comprising a language used by the recipient's UE.

According to yet another preferred embodiment of the invention, there is provided a messaging center comprising an input/output interface, a processor operationally connected to the input/output interface, and an instructions repository storing instructions that when executed by the processor cause the later to instruct the input/output interface to send a message written in a first language to a recipient's UE. Responsive to the sent message, the input/output interface receives an indication of improper delivery of the message to the recipient's UE, and the instructions further cause the processor to determine a second language associated with the recipient's UE and to instruct the input/output interface to request a translation of the message from the first language into the second language associated with the recipient's UE, and to send the message translated into the second language to the recipient's UE.

According to yet another preferred embodiment of the invention, there is provided a UE comprising an input/output interface receiving a message written in a first language, a processor operationally connected to the input/output interface, and an instructions repository storing instructions that when executed by the processor responsive to the received message cause the processor to instruct the input/output interface to send an indication of improper delivery of the message to the recipient's UE, the indication comprising a second language used by the recipient's UE.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is an exemplary network diagram of a telecommunications network where the preferred embodiment of the present invention may be implemented;

FIG. 2 is an exemplary nodal operation and signal flow diagram of the telecommunications network according to the preferred embodiment of the invention;

FIG. 3 is a block diagram of an exemplary messaging center according to the preferred embodiment of the invention; and

FIG. 4 is a block diagram of exemplary user equipment according to the preferred embodiment of the invention.

### DETAILED DESCRIPTION

According to the present invention, there is provided a messaging translation solution that makes use of a language preferred by a user of a device, such as for example of a language set by default in the recipient user's device, for having a transparent translation performed for the recipient user that does not necessarily require intervention neither from the sender's side nor from the receiver user's side. Based on such a technique, a message is automatically translated by an application deployed in the network, for example, from a first language used at the originating side to another language used at the terminating side. Therefore, a user of a recipient device always receives a message in a language and a character set that he or she can understand. Likewise, in the particular case where the recipient user travels abroad, he or she always receives the message already translated in his or her own language. Finally, if a user is the target of an advertisement campaign that may be even originated in another country, he or she will still receive the message in his or her own language and with the proper character set.

According to the present invention, a message written in a first language is sent from a sending user and received by a messaging center, which further attempts a delivery of the message to the recipient's User Equipment (UE). Responsive to the sent message, the messaging center receives an indication of the improper delivery of the message to the recipient's UE, due for example to a mismatch between the language of the message and the language set by default in the recipient user's UE. Such an indication of the improper delivery may comprise a delivery report that indicates the message written in the first language either has failed to properly display on the recipient's UE display, or is otherwise incompatible with the default language set in the UE on the receiving side. Afterwards, the messaging center determines the default language associated with the recipient's UE (e.g. based on information within the delivery report), and requests a translation of the message from the first language into the language associated with the recipient UE, before sending the translated message towards its intended destination. According to the preferred embodiment of the invention, such a translation technique can be applied to various messaging technologies including but not limited to emails systems, SMS (Short Messaging Service) systems, MMS (Multimedia Messaging System) systems, IM (Instant Messaging), and the like.

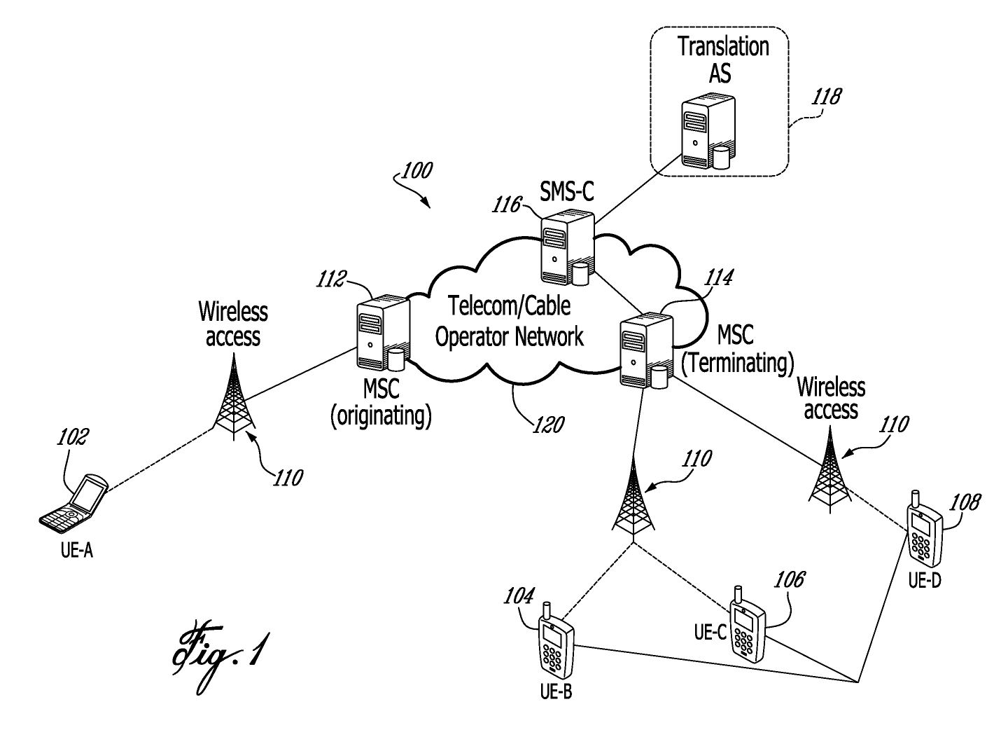

Reference is now made to FIG. 1, which shows a network diagram of an exemplary telecommunications network 100 implementing the preferred embodiment of the present invention. While it is to be understood that the invention can be implemented advantageously with various messaging technologies as mentioned hereinbefore, the FIG. 1 provides an example of an implementation in a cellular telecommunications network using SMS messaging. Represented therein is a UE A 102 which is provided radio service and coverage by a wireless access based station 110 in communication with a Mobile Switching Center (MSC) 112 connected to a core telecommunications network 120. On the receiver side, is another MSC 114 serving other based stations 110 that provide radio service and coverage to the UE B 104, UE C 106 and UE D 108. An SMS messaging center 116 is also represented for handling messages, such as SMS messages, for the entire network 100. Connected to the SMS center 116 is a translation application server 118 that implements translation services in accordance with the preferred embodiment of the present invention. When the user of a UE A 102 sends an SMS message destined for example to the group of users UE B 104, UE C 106 and UE D 108, the sent SMS message is delivered in its originally written language to the recipient users. If any one of the recipient users reports an improper delivery of the message based on the language of the message, the SMS center 116 requests the translation AS 118 for the translation of the message into the languages associated with each one of the recipient users of the UE's 104 through 108. Then, the translated message is sent to the recipients. This allows for a seamless transmission of the message in the language understood by the recipient(s) that does not require mandatory user intervention.

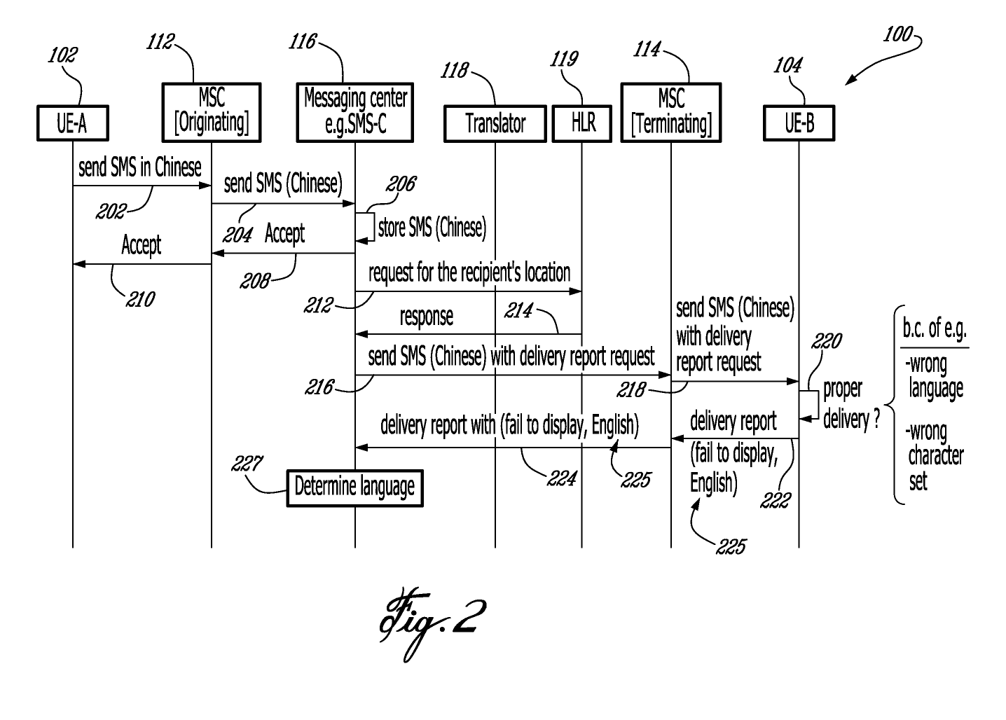

Reference is now made to FIG. 2, which shows a nodal operation and signal flow diagram of an exemplary telecommunications network 100 implementing the preferred embodiment of the invention. Represented therein is an exemplary UE A 102 sending a message, such as for example an SMS message to another UE B 104, and the same telecommunications nodes as described hereinbefore, including for example, the originating MSC 112 supporting communications from and to the UE A 102, a messaging center such as for example the SMS center 116, a translator application server 118, the MSC 114 providing communications support for UE B 104 and a Home Location Register (HLR) 119 that stores information relating to the subscribers of the network 100. In action 202, the UE A user sends an SMS message destined to the UE B 104, the message being written in a first language, such as for example in the Chinese language. The MSC 112 receives the SMS message and sends it further to the SMS center 116 where the message is stored as per regular procedures. Confirmation of the acceptance of the message by the SMS center 116 is sent back to UE A 102 via the messages 208 and 210. In order for the delivery of the message to take place, the SMS center 116 sends a request for the recipient user location to the HLR 119 in action 212, and receives back from the HLR a response 214 providing the location of UE B 104. In action 216, the SMS center 116 sends the SMS message written in the first language, i.e. in Chinese, with the delivery report request. Such a delivery report request is typically a flag embedded in the SMS message's header that requests the recipient to confirm the proper delivery of the SMS. In action 216, the MSC 114 that serves the UE B 104 receives the SMS message and in action 218 it forwards the SMS message along with the delivery report to the recipients UE B 104. Upon receipt of the SMS message written in Chinese, UE B 104 determines in action 220 whether or not the message is written in the language understood by the user UE B 104, or alternatively whether or not it is written using a character set that is supported and understood by the UE B. For Example, the determination of action 220 may include a comparison between the language of the SMS language, i.e. Chinese, with a default language set for use in the UE B 104, or with a default character set for use in the UE B 104, or both. The following table shows a number of examples of the forms the determination 220 may take according to the preferred embodiment of the invention:

| Determination 220 = | | Determination 220 = | |
|---|---|---|---|
| proper delivery of message | | improper delivery of message | |
| 1 | Language of message = | 1 | Language of message |
| | language set by default in UE | | is different than |
| | | | language set by default in UE |
| 2 | Character set used in | 2 | Character set used in message |
| | message = Character set | | is different than |
| | used/available in UE | | Character set used/ |
| | | | available in UE |
| 3 | 1 AND 2 above | 3 | Only one out of (1 and 2 above) |

The UE B may have a default language set for use therein. When the message is received, a messaging application is notified which attempts to decode the message using the default device language. If the decoding succeeds, the UE B 104 displays and renders the message to the end user on the screen. However, in case the determination of action 220 is to the effect that the SMS was written in a language which is unsupported or not understood or not set as the default language by UE B 104 (i.e. a language mismatch is detected), a delivery report is sent back in action 222 with an indication that an improper delivery of the message to the recipient's UE. The delivery report is received by MSC 114 and forwarded in action 224 to SMS center 116. Such a delivery report may also comprise, beyond the indication that the message has failed to be properly delivered, e.g. because it has failed to be displayed properly or was not understood by the recipient user, a further indication 125 indicative of a default (or desired) language associated with the recipient UE, which for the sake of the present example is assumed to be the English language. In action 227, the SMS center 116 determines the language associated with a UE B 104, for example by extracting the indication 225 from the delivery report 224. Being now provided with the language that the user of the UE B 104 understands, or prefers, in action 226, the SMS center 116 requests the translation of the SMS message from the Chinese language into the English language, wherein such a translation is effectuated by the translator application server 118. Action 226 may comprise the transmission of the entire payload of the SMS message written in Chinese to the translator application server 118, along with the indication of the source language and the target language for translation. Once the translation is completed by the translator 118, the later sends back in action 228 a confirmation of the translation along with the translated SMS message in the target English language. In action 230, the SMS center 116 inquires again for the location of the UE B 104 which it receives back in action 232. The SMS center 116 is now in condition to send the translated SMS message to UE B 104. In action 234, the translated version of the SMS message is sent, optionally including a delivery report request, to the MSC 114, which in action 236 forwards the translated SMS message with the delivery report request to the UE B 104. In action 238, the UE B 104 again determines if the language of the SMS of action 236 is supported or understood by the recipient. Because the SMS is now translated in the English language which is the language set by default for use at the UE B 104, in action 240 the UE B 104 sends a successful delivery report including an indication 241 of the language in which the message was written, which in the present case is the English language. The successful delivery report is forwarded from the MSC 114 to the SMS center 116, action 242. Upon receipt of the successful delivery report, the SMS center 116 understands that it can now delete the SMS message that it had stored in action 206, action 244. Furthermore, because the successful delivery of the SMS message has been now confirmed, the SMS center 116 may confirm to the UE A 102 the successful delivery, in action 246, which may comprise an indication that the SMS message has been delivered to the UE B in a translated version, from the originally written Chinese language into the target English language.

While FIG. 2 has been described in relation with an exemplary preferred embodiment of the invention implemented in a cellular network using SMS messaging technology, it is to be understood that the invention may likewise apply to other messaging technologies in a substantially similar form. For example, the UE A and the UE B may be email users using email messaging, in which case the MSC 112 and the MSC 114 may be replaced by e.g. data routers, the SMS center 116 may be replaced by an email server, and wherein the translator application server 118 may be a translator application that translates emails messages rather than SMS messages, and the HLR 119 may be replaced by another subscriber information node, or may be omitted all together. Likewise, the implementation of FIG. 2 may also apply to MMS messaging technologies or instant messaging technologies, wherein the SMS center 116 is replaced with a MMS center, or instant messaging center, all of which are described herein under the more generic name of a messaging center. Furthermore, the functionalities described in FIGS. 1 and 2 related to the messaging center 116 and the translator application server 118 may also be implemented in various forms, including for example, separated physically (as shown in FIGS. 1 and 2) or logically, or combined together in a co-located node, or within the same logical node.

In a variant of the preferred embodiment of the invention, there is provided another way for determining the target language for translation for the message of FIG. 2. For example, the delivery report 222 and 224 may comprise an indication that the language of the SMS message written in Chinese was not understood using the character set supported by the recipient's UE B, without necessarily including the indication of the desired language 225. Therefore, in action 227, the SMS center 116 may use the delivery report indicative of an improper delivery based on the language used by the UE B 104 in further conjunction with the default language associated with a home network (not shown) of the UE B 104, in order to determine that the SMS center is to be translated into, for example, the English language, as follows:
1. determine the improper delivery (e.g. based on the message's character set)
2. determine the language of the home network of UE B

In to yet another variant of the preferred embodiment of the invention, the determination of the language of action 227 may take yet another form. According to this variant, the delivery report of action 222 and 224 may also be limited to an indication of improper delivery as mentioned hereinbefore, and in such a case in action 227 the SMS center 116 may further determine the language used in SMS messages originated in the past by the UE B 104, or inquire with another SMS center of the language used in SMS messages originated in the past by the UE B 104, as follows:
1. determine the improper delivery (e.g. based on the message's character set)
2. determine the language used in previous messages originated by UE-B

The purpose of such a determination is to determine the language used, or mostly used, in messages that were created by the user of UE B 104 in order to determine a language, and possibly a character set, that is both supported and understood by the user of the UE B 104. Once such a determination takes place in action 227, the SMS center 116 knows in which language the SMS message as to be translated for proper delivery to the UE B 104.

There are other combinations of other parameters that may be employed according to the preferred embodiment of the invention, in conjunction with the delivery report 222 and 224, in order to determine the proper language in which the SMS message has to be translated in order for it to be understood by the UE B 104, including, for example, the language of a country or city of residence of the recipient user (e.g. retrieved or accessible from an HLR or equivalent).

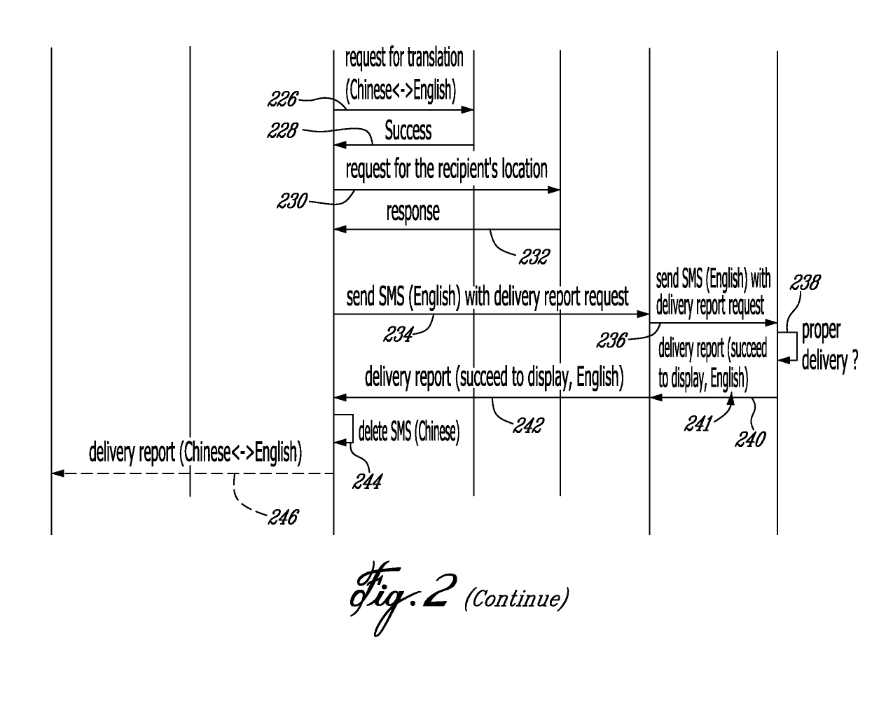

Reference is now made to FIGS. 3, which shows a simplified block diagram of an exemplary messaging center 116 that may include a SMS center as described in relation to FIG. 2, or alternatively an MMS center, an IM center, an email server, or an IMS messaging center 116. Independently of the form taken by the messaging center 116, it is to be understood that it functions in a manner substantially similar to the one described in relation to FIG. 2 and its exemplary SMS center in order to perform and insure the proper translation of incoming message, such as for example the SMS message 204 into a proper language for delivery to a recipient user, like the UE B 104.

The messaging center 116 first comprises input/output (communication) interface 306 for communication with other nodes of the network 100, such as for example with UEs alike UE A 102 and UE B 104 and with other nodes like for example the MSCs 112 or 114 and the translator application server 118. The messaging center 116 further comprises a processor 302 operationally connected to the input/output interface and an the instructions repository 304 storing instructions that when executed by the processor 302 cause the later to perform, on behalf of the messaging center 116, the actions described herein before in relation to the messaging center 116 of the FIG. 2. For example, such instructions, when executed by the processor 302 may cause the processor to instruct the input/output interface 306 to send a message written in the first language to a recipient's UE, wherein responsive to the sent message, the input/output interface 306 receives an indication of improper delivery of the message to the recipient's UE. The instructions further cause the processor to determine a default language associated with the recipient's UE and to further instruct the input/output interface 306 to request the translation of the message from the first language into a default language used by the recipient, and to send the message translated into the default language to the recipients' UE. Likewise, the instruction repository 304 may comprise further instructions that when executed the processor 302 cause the later to perform the determination of the language of the UE B 104 as described herein before in relation to action 227 of FIG. 2. Finally, the instruction repository 304 may comprise additional instructions for causing the processor 302 to instruct the input/output interface 306 to send out all the messages originated at the SMS center 116 as described herein before in relation to the FIG. 2.

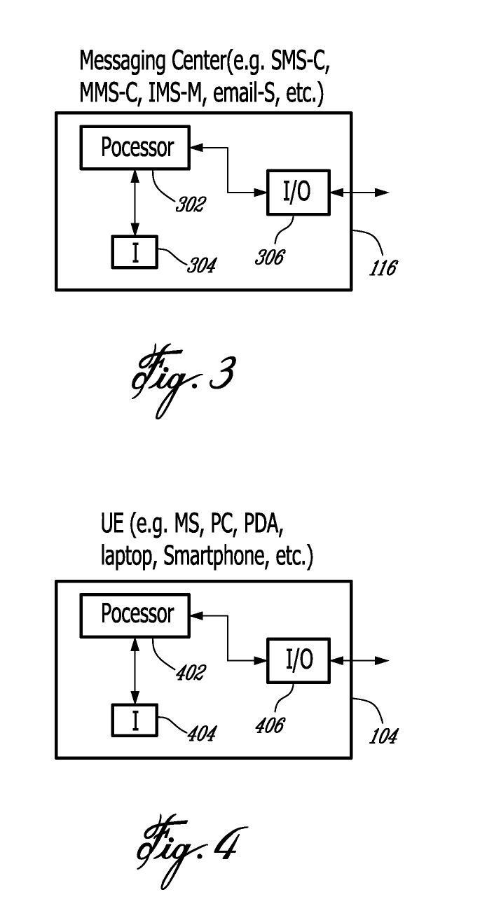

Reference is now made to FIG. 4, which shows an exemplary implementation of a UE alike the UE B 104, which may take the form of a mobile station, a personal computer, a personal digital assistant, a laptop, a smart phone etc. Independently of the form taken by the UE 104, the later functions to receive one or more given type of messages (e.g. SMS, MMS, IM, email, etc) and for this purpose comprises an input/output interface 406 supporting messaging communications with external nodes, a processor 402 operationally connected to the input/output interface 406, and an instructions repository 404. The later stores instructions that when executed by the processor 402, responsive to a message written in the first language being received by the input/output interface, cause the processor 402 to instruct the input/output interface 406 to send an indication of improper delivery of the message, wherein in the indication may comprise a default language set in the UE 104. Furthermore, the instructions repository 404 may store additional instructions that when executed by the processor 402 cause the processor 402 to instruct the input/output interface 406 to process and send the messages that originate at the UE B 104 as described in relation to the FIG. 2, and also to perform the actions related to the UE B 104, such as for example actions 220 and 238 as described in relation to the FIG. 2.

Those skilled in the art would appreciate that the preferred embodiment of the present invention allows for a smooth and transparent translation of messages sent to a user to another user, in a manner that is both transparent to the recipient user and also to the sending user. While FIG. 2 described a simplified scenario with a sending user and a receiving user, it is to be understood that the translation scenario described in relation to FIG. 2 can be extended to multiple recipients. For example, the UE A 102 (e.g. a user or a commercial application sending messages to multiple-user) may send a message 202 that is destined to a plurality of users including UE B 104. In such a scenario, it is understood that the preferred embodiment of the invention as described in FIG. 2 may be replicated, for example, for each one of the intended recipient, so that each such recipient receives the message in his/her preferred language.

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

Based upon the foregoing, it should now be apparent to those of ordinary skills in the art that the present invention provides an advantageous solution, which offers data efficient translation of messages in telecommunications networks. Although the system and method of the present invention have been described in particular reference to certain telecommunications messaging standards (for example SMS), it should be realized upon reference hereto that the innovative teachings contained herein are not necessarily limited thereto and may be implemented advantageously with any applicable telecommunications standard. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth herein below.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for message translation comprising the steps of:
a. sending a message written in a first language from a messaging center to a recipient's User Equipment (UE);
b. in response to the sending of the message, receiving an indication of improper delivery of the message to the recipient's UE;
c. determining a second language associated with the recipient's UE;
d. requesting by the messaging center a translation of the message from the first language into the second language associated with the recipient's UE; and
e. sending the message translated into the second language to the recipient's UE.

2. The method of claim 1 wherein the message is a Short Messaging Service (SMS) message and the messaging center is an SMS Center.

3. The method of claim 1 wherein the indication of improper delivery comprises a delivery report indicative that the message written in the first language has failed to be properly displayed on the recipient's UE display.

4. The method of claim 1 wherein the indication of improper delivery comprises a delivery report with an indication of the recipient's UE default language, wherein step c. is performed using the indication of the recipient's UE default language.

5. The method of claim 1 wherein step c. is performed using at least i) the indication of improper delivery of the message to the recipient's UE, and ii) a language that is associated with a home network of the recipient's UE.

6. The method of claim 1, further comprising the steps of:
f. responsive to step e., receiving an indication of proper delivery of the translated message to the recipient's UE.

7. The method of claim 6, wherein the indication of proper delivery comprises an indication of a default language of the recipient's UE in which the message was translated, whereby the default language is the second language.

8. The method of claim 7, further comprising the step of:
g. sending the indication of proper delivery of the translated message along with the indication of the default language in which the message was translated to a UE that originated the message written in the first language.

9. A method for message translation comprising the steps of:
a. receiving at a User Equipment (UE) a message written in a first language; and
b. responsive to the received message, sending an indication of improper delivery of the message to the recipient's UE, the indication comprising a language used by the recipient's UE.

10. The method claims in claim 9, further comprising the step of:
c. prior to step b., determining a mismatch between the first language and the language used by the UE.

11. The method of claim 9, further comprising the step of:
c. responsive to sending the indication of improper delivery, receiving the message translated into the language used by the recipient's UE.

12. The method of claim 10, further comprising the step of:
d. responsive to step c., sending an indication of proper delivery of the translated message to a UE that originated the message written in the first language.

13. The method of claim 11, wherein the indication of proper delivery comprises an indication of the language used by the recipient's UE in which the message was translated.

14. A messaging center comprising:
an input/output interface;
a processor operationally connected to the input/output interface;
an instructions repository storing instructions that when executed by the processor cause the later to instruct the input/output interface to send a message written in a first language to a recipient's User Equipment (UE), wherein responsive to the sent message, the input/output interface receives an indication of improper delivery of the message to the recipient's UE, wherein the instructions further cause the processor to determine a second language associated with the recipient's UE and to instruct the input/output interface to request a translation of the message from the first language into the second language associated with the recipient's UE, and to send the message translated into the second language to the recipient's UE.

15. The messaging center of claim 14 wherein the message is a Short Messaging Service (SMS) message and the messaging center is an SMS Center.

16. The messaging center of claim 14 wherein the indication of improper delivery comprises a delivery report indicative that the message written in the first language has failed to be properly displayed on the recipient's UE display.

17. The messaging center of claim 14 wherein the indication of improper delivery comprises a delivery report with an indication of the recipient's UE default language, wherein in order to determine the second language associated with the recipient's UE the processor uses the indication of the recipient's UE default language.

18. The messaging center of claim 14 wherein in order to determine the second language associated with the recipient's UE, the processor uses at least i) the indication of improper delivery of the message to the recipient's UE, and ii) a language associated with a home network of the recipient's UE.

19. The messaging center of claim 14, wherein responsive to the sending to the recipient's UE of the message translated into the second language, the input/output interface receiving an indication of proper delivery of the translated message to the recipient's UE.

20. The messaging center of claim 19, wherein the indication of proper delivery comprises an indication of the default language of the recipient's UE in which the message was translated, whereby the default language is the second language.

21. The messaging center of claim 20, wherein the input/output interface sends to a UE that originated the message written in the first language the indication of proper delivery of the translated message along with the indication of the default language of the recipient's UE in which the message was translated.

22. A User Equipment (UE) comprising:
an input/output interface receiving a message written in a first language;
a processor operationally connected to the input/output interface;
an instructions repository storing instructions that when executed by the processor responsive to the received message cause the processor to instruct the input/output interface to send an indication of improper delivery of the message to the recipient's UE, the indication comprising a second language used by the recipient's UE.

23. The UE of claim 22, wherein the instructions repository stores further instructions that when executed by the processor cause the processor determine a mismatch between the first language and the language used by the UE.

24. The UE of claim 22, wherein the input/output interface further receives the message translated into the second language used by the recipient's UE.

25. The UE of claim 24, wherein responsive to the input/output interface receiving the message translated into the default language of the UE, the input/output interface sends an indication of proper delivery of the translated message to the recipient's UE.
